(19) United States
(12) Patent Application Publication
(10) Pub. No.: US 2015/0337597 A1
(43) Pub. Date: Nov. 26, 2015

(54) COLLAPSIBLE LADDER ARRANGEMENT AND METHOD OF ATTACHING A WEBBING SUPPORT TO A RUNG OF THE SAME

(71) Applicant: Carrier Corporaton, Farmington, CT (US)

(72) Inventor: Henry Arnette, Mebane, NC (US)

(21) Appl. No.: 14/716,284

(22) Filed: May 19, 2015

Related U.S. Application Data
(60) Provisional application No. 62/000,767, filed on May 20, 2014.

(51) Int. Cl. E06C 7/50; E06C 1/34

(52) U.S. Cl. CPC E06C 7/50; E06C 1/34

(57) ABSTRACT

A collapsible ladder arrangement includes, a plurality of rungs, and at least one webbing support that is frictionally engaged with each of the plurality of rungs to resist relative movement between the at least one webbing support and each of the plurality of rungs. The frictional engagement is established without an end of the at least one webbing support having been threaded through an opening in the plurality of rungs and without the at least one webbing support frictionally engaging with itself.

### CROSS-REFERENCE TO RELATED APPLICATIONS

This application claims the benefit of U.S. provisional patent application Ser. No. 62/000,767, filed May 20, 2014, the entire contents of which are incorporated herein by reference.

### BACKGROUND

Collapsible ladders are commonly employed during an emergency escape, including from an upper floor of a burning building, for example. It is desirable that such ladders be foldable into a compact package for ease of storage, be light weight, be easily deployed from a window, be safe to use and reasonably priced. Although there are ladders on the market that meet these criteria new designs and methods of making such ladders are always of interest to those in the industry.

### BRIEF DESCRIPTION

According to one embodiment of the invention, a collapsible ladder arrangement is provided, wherein a plurality of rungs, and at least one webbing support that is frictionally engaged with each of the plurality of rungs to resist relative movement between the at least one webbing support and each of the plurality of rungs. The frictional engagement is established without an end of the at least one webbing support having been threaded through an opening in the plurality of rungs and without the at least one webbing support frictionally engaging with itself.

In addition to one or more of the features described above, or as an alternative, in further embodiments the at least one webbing support is positioned along a circuitous path relative to each of the plurality of rungs.

In addition to one or more of the features described above, or as an alternative, in further embodiments the circuitous path includes the at least one webbing support bending through at least two bends of at least 90 degrees around the plurality of rungs or a member attachable to each of the plurality of rungs.

In addition to one or more of the features described above, or as an alternative, in further embodiments a plurality of fasteners, with at least one of the plurality of fasteners being fixedly engaged with both the at least one webbing support and at least one of the plurality of rungs.

In addition to one or more of the features described above, or as an alternative, in further embodiments the fasteners are selected from the group consisting of rivets, screws, pins and staples.

In addition to one or more of the features described above, or as an alternative, in further embodiments

In addition to one or more of the features described above, or as an alternative, in further embodiments a plurality of standoffs, with at least one standoff being in operable communication with each of the plurality of rungs.

In addition to one or more of the features described above, or as an alternative, in further embodiments the portion of the at least one webbing support is frictionally engaged with both the at least one of the plurality of standoffs and the one of the plurality of rungs.

In addition to one or more of the features described above, or as an alternative, in further embodiments a fastener fixes the portion of the at least one webbing support, the at least one of the plurality of standoffs and the one of the plurality of rungs together.

In addition to one or more of the features described above, or as an alternative, in further embodiments at least a feature of one of the plurality of standoffs and the one of the plurality of rungs is inserted into the other of the at least a feature of one of the plurality of standoffs and the one of the plurality of rungs.

According to one embodiment of the invention a method of attaching webbing support to a rung of a collapsible ladder arrangement comprising positioning a portion of a webbing support into a circuitous path about a rung of the collapsible ladder arrangement without threading an end of the webbing support through a hole in the rung and without frictionally engaging the webbing support to itself.

In addition to one or more of the features described above, or as an alternative, in further embodiments applying a fastener to at least the rung and the webbing support.

In addition to one or more of the features described above, or as an alternative, in further embodiments positioning the portion of the webbing support between the rung and a standoff.

In addition to one or more of the features described above, or as an alternative, in further embodiments frictionally engaging the webbing support with the rung.

In addition to one or more of the features described above, or as an alternative, in further embodiments the routing the portion of the webbing support includes bending the webbing support through at least two bends of at least 90 degrees relative to the rung.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a partial perspective view of a collapsible ladder arrangement disclosed herein;

FIG. 2 depicts a partial cross sectional view of the collapsible ladder arrangement of FIG. 1;

FIG. 3 depicts an exploded view of a portion of the collapsible ladder arrangement of FIG. 1;

FIG. 4 is a partial perspective view of an alternate embodiment of a collapsible ladder arrangement disclosed herein;

FIG. 5 depicts a partial cross sectional view of the collapsible ladder arrangement of FIG. 4;

FIG. 6 is a partial perspective view of an alternate embodiment of a collapsible ladder arrangement disclosed herein; and

FIG. 7 depicts a partial cross sectional view of the collapsible ladder arrangement of FIG. 6.

### DETAILED DESCRIPTION

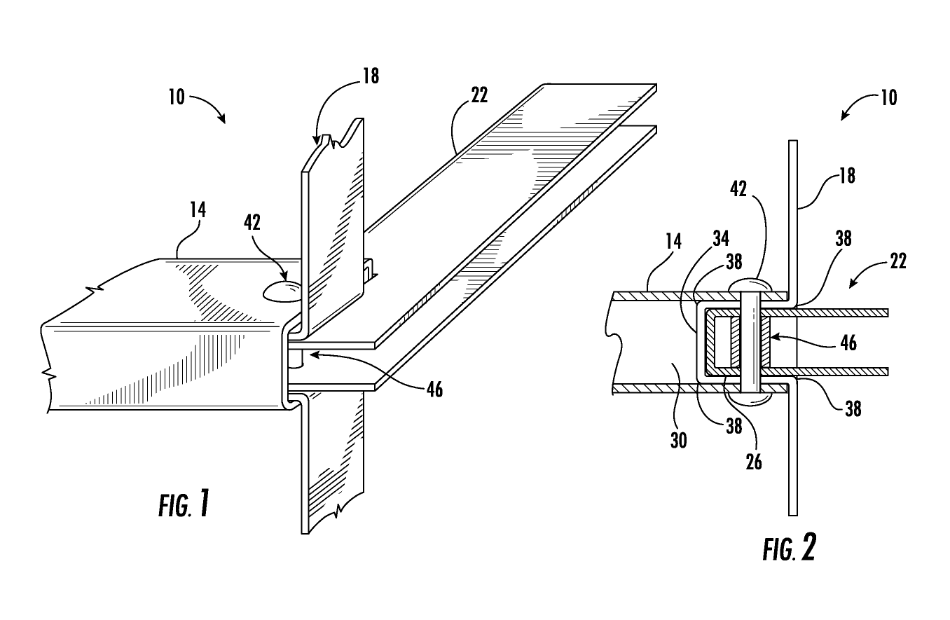

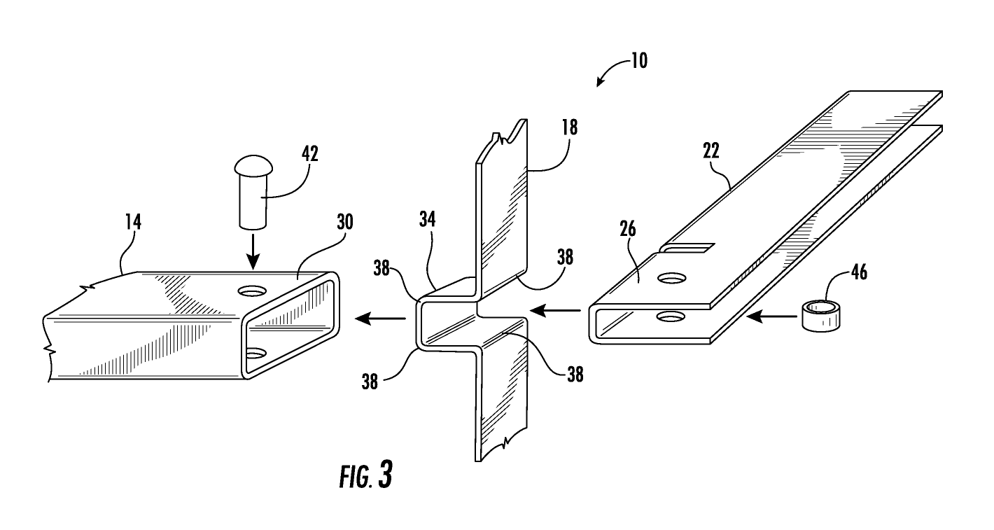

Referring to FIGS. 1 through 3, an embodiment of a collapsible ladder arrangement disclosed herein is illustrated generally at 10. The collapsible ladder arrangement 10 includes a plurality of rungs 14 and at least one webbing support 18 in operable communication with the plurality or rungs 14. The arrangement 10 includes two of the webbing supports 18 (and other components described herein), one located proximate either end of the rungs 14, even though only one of the webbing supports 18 (and other components described herein) is shown in the Figures. The webbing support 18 is frictionally engaged with each of the rungs 14 to resist relative movement between the webbing support 18 and each of the rungs 14. The frictional engagement is established between the webbing support 18 and the rungs 14 without an end of the webbing support 18 having been threaded through an opening in any of the plurality of rungs 14 and without the webbing support 18 being frictionally engaged with itself (i.e. the webbing support 18 is not tied in a knot around the rungs 14) or sewn to itself.

A standoff 22 is sized and configured to have a feature 26 slidably engagable with a pocket 30 formed in the rung 14 with a portion 34 of the webbing support 18 being sandwiched therebetween. The foregoing positions the portion 34 of the webbing support 18 in a circuitous path relative to the rung 14 thereby creating frictional engagement between at least the portion 34 and the rung 14. The frictional engagement is created in part by at least two bends 38 of at least 90 degrees each formed in the portion 34 that is wrapped around the rung 14. This embodiment also includes two additional bends 38 of at least 90 degrees formed in the portion 34 that is wrapped around the feature 26 of the standoff 22.

A fastener 42, illustrated as a rivet (though screws, pins and staples and any other suitable means for fastening are also contemplated), fixedly attaches the rung 14, to the standoff 22 and to the portion 34 of the webbing support 18. In addition to the frictional engagement described above, the fastener 42 prevents relative movement between the webbing support 18 and the rung 14. An optional spacer 46 can be employed to prevent collapse of the standoff 22 and the rung 14.

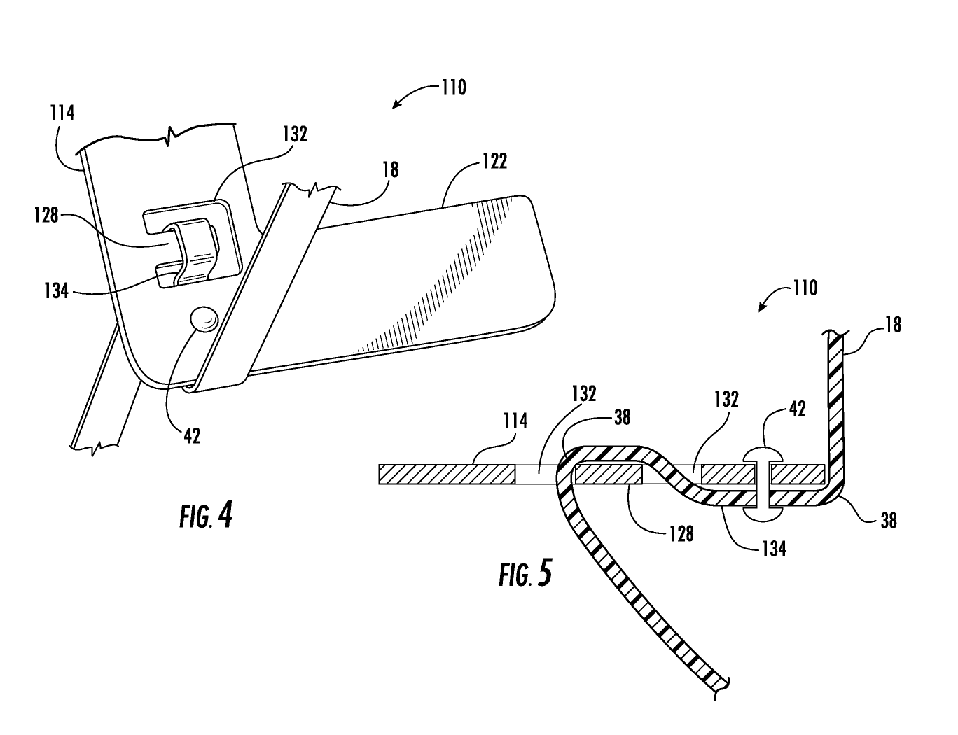

Referring to FIGS. 4 and 5, an alternate embodiment of a collapsible ladder arrangement disclosed herein is illustrated generally at 110. The arrangement 110 shares many aspects with those of the arrangement 10. For example, neither requires that an end of the webbing support 18 be threaded through a hole formed in the rung 14 or 114 or the standoff 22 or 122, thereby eliminating a need to pull a significant length of the webbing support 18 through the hole as is required of some conventional ladders on the market. A rung 114 of the arrangement 110 has two standoffs 122 (although only one is shown in the Figures) integrated therein. The rung 114 also has two tabs 128 (although only one is shown in the Figures) integrated therein. The tab 128 defines a U-shaped opening 132 that allows a portion 134 of the webbing support 18 to be bent and positioned around the tab 128. Two bends 38 in the webbing support 18 wrap around the rung 114 and the tab 128 providing frictional engagement therebetween. Optionally the fastener 42 can be employed to further assure the portion 134 is fixed relative to the rung 114 to which it is proximally positioned.

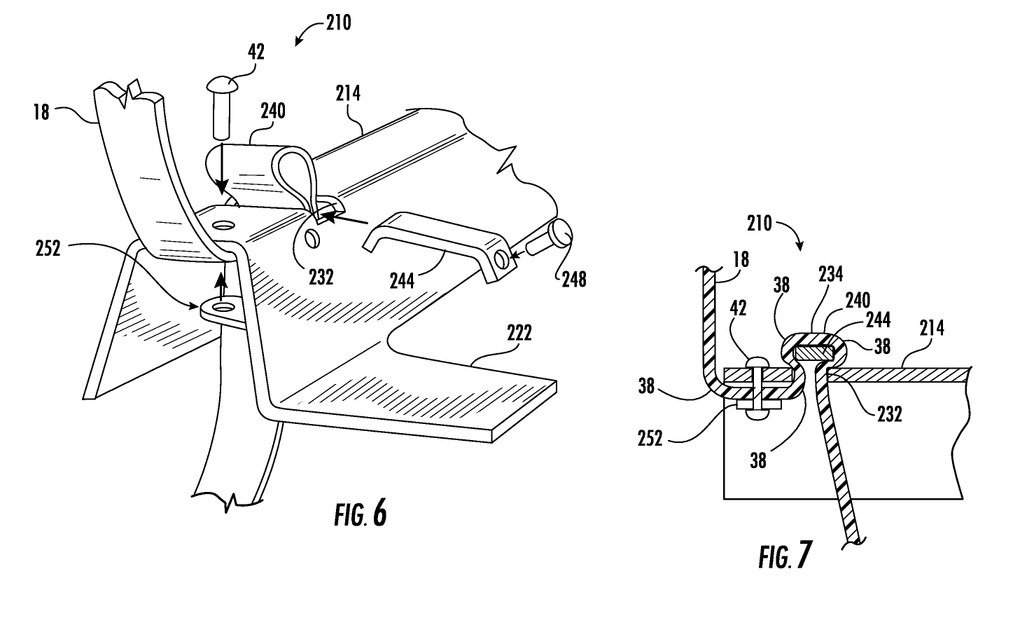

Referring to FIGS. 6 and 7, an alternate embodiment of a collapsible ladder arrangement disclosed herein is illustrated generally at 210. The arrangement 210 shares many aspects with those of the arrangements 10 and 110. For example, none require that an end of the webbing support 18 be threaded through a hole formed in the rung 14, 114 or 214. The arrangement 210 includes a rung 214 having two standoffs 222 (although only one is shown in the Figures) integrated therein. The rung 214 also has two openings 232 (although only one is shown in the Figures) formed therein. The opening 232 allows a portion 234 of the webbing support 18 to be folded to form a loop 240 that can be fed through the opening 232. A retainer 244 can be positioned within the loop 240 and held thereby by friction with the webbing support 18 or with one or more fasteners 248. Additionally, as with the arrangements 10 and 110 the arrangement 210 can also use a fastener 42 to fixedly attach the webbing support 18 to the rung 214. An optional washer 252 can also be employed to distribute load from the fastener 42 over a larger area of the webbing support 18. The arrangement 210 employs two bends 38 of the webbing support 18 with the rung 214 and two bends 38 of the webbing support 18 with the retainer 244.

It should be appreciated that a process by which the loop 240 is formed and threaded through the opening 232 is much simpler and quicker to accomplish than conventional ladders that require an end of a webbing support be inserted through a hole in a rung and then a significant length of the webbing support being run through the hole.

It should further be appreciated that none of the collapsible ladder arrangements 10, 110, 210 disclosed herein require sewing of the webbing support 18 to itself or to other similarly constructed webbing supports.

Additionally, various specifications may be used to evaluate the load handling capability of ladders, including the following. Representative samples of ladders constructed according to each of the collapsible ladder arrangements 10, 110, 210 shall be mounted such that the rungs 14, 114, 214, respectively, are supported substantially horizontally by two vertically oriented pieces of the webbing support 18. The rungs 14, 114, 214 and the webbing supports 18 must support a minimum of 250 pounds distributed evenly thereacross for one minute. The rungs 14, 114, 214 and the webbing supports 18 must support a minimum of 850 pounds distributed over 4 inches in the center thereof for one minute. In addition, the rungs 14, 114, 214 and the webbing supports 18 must support a minimum of 750 pounds distributed over 4 inches adjacent to where either of the webbing supports 18 is attached thereto for one minute.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A collapsible ladder arrangement, comprising:
a plurality of rungs; and
at least one webbing support being frictionally engaged with each of the plurality of rungs to resist relative movement between the at least one webbing support and each of the plurality of rungs, the frictional engagement being established without an end of the at least one webbing support having been threaded through an opening in the plurality of rungs and without the at least one webbing support being frictionally engaged with itself.

2. The collapsible ladder arrangement of claim 1, wherein the at least one webbing support is positioned along a circuitous path relative to each of the plurality of rungs.

3. The collapsible ladder arrangement of claim 2, wherein the circuitous path includes the at least one webbing support bending through at least two bends of at least 90 degrees around the plurality of rungs or a member attachable to each of the plurality of rungs.

4. The collapsible ladder arrangement of claim 1, further comprising a plurality of fasteners, with at least one of the plurality of fasteners being fixedly engaged with both the at least one webbing support and at least one of the plurality of rungs.

5. The collapsible ladder arrangement of claim 4, wherein the fasteners are selected from the group consisting of rivets, screws, pins and staples.

6. The collapsible ladder arrangement of claim 1, further comprising a plurality of standoffs, with at least one standoff being in operable communication with each of the plurality of rungs.

7. The collapsible ladder arrangement of claim 6, wherein at least one of the plurality of standoffs locates a portion of the at least one webbing support between itself and one of the plurality of rungs.

8. The collapsible ladder arrangement of claim 7, wherein the portion of the at least one webbing support is frictionally engaged with both the at least one of the plurality of standoffs and the one of the plurality of rungs.

9. The collapsible ladder arrangement of claim 7, wherein a fastener fixes the portion of the at least one webbing support, the at least one of the plurality of standoffs and the one of the plurality of rungs together.

10. The collapsible ladder arrangement of claim 7, wherein at least a feature of one of the plurality of standoffs and the one of the plurality of rungs is inserted into the other of the at least a feature of one of the plurality of standoffs and the one of the plurality of rungs.

11. A method of attaching webbing support to a rung of a collapsible ladder arrangement comprising positioning a portion of a webbing support into a circuitous path about a rung of the collapsible ladder arrangement without threading an end of the webbing support through a hole in the rung and without frictionally engaging the webbing support to itself.

12. The method of attaching webbing support to a rung of a collapsible ladder arrangement of claim 11, further comprising applying a fastener to at least the rung and the webbing support.

13. The method of attaching webbing support to a rung of a collapsible ladder arrangement of claim 11, further comprising positioning the portion of the webbing support between the rung and a standoff.

14. The method of attaching webbing support to a rung of a collapsible ladder arrangement of claim 11, further comprising frictionally engaging the webbing support with the rung.

15. The method of attaching webbing support to a rung of a collapsible ladder arrangement of claim 11, wherein the routing the portion of the webbing support includes bending the webbing support through at least two bends of at least 90 degrees relative to the rung.
